(19) United States
(12) Patent Application Publication
(10) Pub. No.: US 2012/0318202 A1
(43) Pub. Date: Dec. 20, 2012

(54) DRINKING VALVE

(76) Inventors: Egon Schumacher, Barnstorf (DE); Wolfgang Meyer, Barnstorf (DE)

(21) Appl. No.: 13/582,121

(22) PCT Filed: Feb. 9, 2011
(86) PCT No.: PCT/EP11/00611

§ 371 Date: Aug. 31, 2012

(30) Foreign Application Priority Data
Mar. 2, 2010 (DE) 10-2010009043.0
Jan. 27, 2011 (DE) 102011009568.3

(51) Int. Cl. A01K 39/02

(52) U.S. Cl. 119/74

(57) ABSTRACT

Drinking valves (10) with a plastics material housing (18) are susceptible to aggressive cleaning agents. The invention makes provision for increasing the wall thickness of the plastics material housing (18) somewhat by the wall thickness corresponding to at least 17% of the maximum inside diameter of the plastics material housing (18). In a surprising manner, it has been shown that a plastics material housing (18) having such a wall thickness is more resistant to aggressive cleaning agents than conventional drinking valves with a plastics material housing.

### BACKGROUND OF THE INVENTION

1. Technical Field

The invention relates to a drinking valve for animal watering troughs, preferably poultry watering troughs, said drinking valve having a plastics material housing which can be connected to a water supply pipe, having a valve pin which protrudes in part down out of the plastics material housing and having a top pin which is arranged above the valve pin.

2. Prior Art

Drinking valves are used in the case of intensive livestock farming of preferably small animals such as chicks, chickens, turkeys or the like. The drinking valves make it possible for the animals to meet their water requirement independently. To this end, the animals actuate an actuating end on a valve pin which protrudes down out of the housing of the drinking valve.

Usually, several drinking valves are assigned to one long watering line. The watering line has at least one water supply pipe to which the drinking valves are connected. As a rule, the drinking valves are screwed into a bottom wall of the water supply pipe by way of a top end region.

The named animal watering trough including the drinking valves has to be cleaned and/or disinfected at regular intervals for reasons of hygiene. Aggressive hygienic cleaning agents are used for this purpose. It has been shown that these impair, above all, the plastics material housings of the drinking valves. In particular, plastics material housings of older drinking valves which have already been cleaned many times with aggressive chemical media are attacked.

### BRIEF SUMMARY OF THE INVENTION

The object underlying the invention is to create a drinking valve for animal watering troughs, preferably poultry watering troughs, which has a plastics material housing and is nevertheless more resistant to aggressive media than previous drinking valves with a plastics material housing.

A drinking valve for obtaining said object is a drinking valve for animal watering troughs, preferably poultry watering troughs, said drinking valve having a plastics material housing which can be connected to a water supply pipe, having a valve pin which protrudes in part down out of the plastics material housing and having a top pin which is arranged above the valve pin, characterized in that the plastics material housing has a wall thickness which amounts to at least 17% of the maximum inside diameter of the plastics material housing. Accordingly, provision is made to provide the plastics material housing with a wall thickness which amounts to at least 17% of the maximum inside diameter of the plastics material housing. Such a wall thickness is greater than in the case of previous drinking valves with a plastics material housing. Surprisingly, it has been shown that a plastics material housing with a wall thickness which is increased in this manner is unsusceptible to aggressive media, in particular cleaning agents. Surprisingly, above all, it has been shown that plastics material housings with such a wall thickness do not crack even when they have been frequently exposed to aggressive media.

It is provided in a preferred manner that the plastics material housing has a wall thickness which is at least 17% of the maximum inside diameter but is no greater than 29% of the maximum inside diameter. If the named maximum wall thickness of the plastics material housing is exceeded, there could be a danger of the plastics material housing being too rigid and as a result aggressive media could cause cracks.

It is additionally provided that an outer surface and/or an inner surface of the plastics material housing are provided with portions of different wall thicknesses. In the case of such a housing, the wall thickness, with reference to the portion with the minimum inside diameter, amounts to a minimum of 23%, and a maximum of 36% of the minimum inside diameter. As an alternative to this or in addition, it is provided that, with reference to the portion of the maximum inside diameter, the wall thickness amounts to a minimum of 17% and a maximum of 29% of the maximum inside diameter. Such maximum and minimum wall thicknesses ensure that, in the case of a stepped plastics material housing, the wall thickness in all the portions, and even in portions with the thin wall thicknesses, still has sufficient thickness in order to avoid, in a reliable manner, damaging influences produced by aggressive media, in particular cracks forming in the plastics material housing.

In the case of a further advantageous development of the drinking valve with a plastics material housing, where the outer surface and/or the inner surface, preferably both the inner surface and the outer surface, have portions of different wall thicknesses, the wall thickness has between 24% and 29%, preferably between 26% and 28%, of the average inside diameter of the plastics material housing in the region of at least half of the overall length of the plastics material housing. This too ensures that, in the case of a stepped plastics material housing, a sufficient wall thickness is always present in order to stop damaging influences of aggressive chemical media, in particular the danger of the plastics material housing cracking.

The particular dimension as claimed in the invention of the wall thickness of the plastics material housing of the drinking valve is proven to be particularly advantageous when the plastics material housing is produced from a particular plastics material, namely acrylonitrile-styrene-acrylester (ASA). It has been shown that precisely in the case of said thermoplastic polymer, the increase in the wall thickness of the plastics material housing results, in particular, in the improvement in the resistance to all chemical media striven for and, in particular, in the elimination of the danger of cracking brought about by aggressive media. However, other thermoplastic polymers in conjunction with the increase in the wall thickness as claimed in the invention can also contribute to the increase in the resistance of the plastics material housing to aggressive media, in particular aggressive chemical media.

In the case of an advantageously developed drinking valve, the valve pin and the top pin are formed from identical or identical-value or identical-type steel, preferably from the identical or identical-value or identical type of high-grade stainless steel. As a result, electrochemical corrosion between the top pin and the valve pin is prevented, especially when the drinking valve is rinsed or cleaned with aggressive chemical media.

In a preferred manner, it is provided that an insert sleeve also of steel, preferably high-grade stainless steel, is formed in the plastics material housing. In a preferred manner, the steel, and in particular the high-grade stainless steel, for forming the insert sleeve is the identical one or of identical-value or identical-type as the steel or high-grade steel for the valve pin and/or the top pin. This also contributes toward avoiding electrochemical corrosion when the drinking valve is provided with the insert sleeve.

According to a preferred further development of the drinking valve, the insert sleeve extends only over a bottom inner part region of the plastics material housing, in particular as far as up to the top pin. The insert sleeve is preferably provided on the top end face thereof with a circumferential sealing seat which corresponds to a circumferential sealing surface on the bottom end face of the top pin. In this way, the top pin only comes into contact with the insert sleeve by way of the sealing surface on the end face thereof. For the rest, the top pin, in particular the outer wall thereof, only contacts the plastics material housing. The inner surface of the plastics material housing, as a rule, is smoother than the wall of the insert sleeve, as a result of which the top pin is easier to move up and down for opening and closing the valve. The smooth plastics material of the plastics material housing forms, as it were, a sliding bearing arrangement for the top pin, which can be moved up and down in the plastics material housing, and also does not tend to get contaminated as quickly.

In the outer lateral surface, the insert sleeve of the drinking valve preferably has a groove-like constriction which extends over part of the length thereof. Said constriction leads to a reduction in the surface, by way of which the insert sleeve is fixed in the plastics material housing in a non-positive manner by means of resilient pre-stressing of the same. Through the reduction in the surface, by way of which the plastics material housing holds the insert sleeve in a non-positive manner, less internal stress is necessary in the plastics material sleeve, as a result of which the danger of impairing the plastics material sleeve by aggressive media is reduced. This applies in particular in conjunction with the increase in the wall thickness of the plastics material housing according to the invention compared to conventional drinking valves with a plastics material housing.

The depth of the constriction in the outer circumference of the insert sleeve, in a preferred manner, amounts to up to 6% of the outer diameter of the insert sleeve outside the region of the constriction. Such a relatively flat constriction of the insert sleeve has proven to be sufficient in order to reduce the stresses in the region of the plastics material housing of the drinking valve surrounding the insert sleeve so much that aggressive media used for cleaning or rinsing the drinking valve, in particular chemical washing liquids, do not result in impairments. The length of the constriction only needs to amount to between 10% and 20% of the overall length of the insert sleeve in order to reduce, in an effective manner, the stress in the plastics material housing for the non-positive fixing of the insert sleeve in said plastics material housing.

In a preferred manner, it is provided that the plastics material housing is provided on the inner surface with a preferably circumferential, ring-like projection. The projection is situated at such a position of the plastics material housing that the ring-like projection of the plastics material housing engages at least partially in the circumferential groove-like indentation or in other words on the outer circumference of the insert sleeve. In this way, the insert sleeve is secured structurally in a positive manner in the plastics material housing. Said positive securement allows for a reduction in the pre-stressing between the insert sleeve and the plastics material housing. By means of the ring-like projection of the plastics material housing, which engages in a positive manner in the constriction of the insert sleeve, the insert sleeve is still reliably secured in the plastics material housing against being pulled out even when the insert sleeve is pressed into the plastics material housing with a relatively small amount of pre-stressing. On account of the reduced pre-stressing of the plastics material housing on the insert sleeve, the drinking valve is more resistant to chemical influences because the mechanical load of the plastics material housing is reduced by means of the smaller amount of pre-stressing.

In the case of another advantageous development of the drinking valve, in the sealing position resting against the insert sleeve on the sealing seat, the top end surface of the top pin deviates by a maximum of 2 mm, preferably only 1 mm, from the plane of the top end surface of the plastics material housing. This means that the end face surface of the top pin and of the plastics material housing extend in an approximately flush manner in a common plane, as a result of which the top pin does not protrude into the water supply pipe or at least protrudes in a negligible manner. As a result, on the one hand, the flow of the water in the water supply pipe remains unimpaired by the top pin and, on the other hand, no exposed part of the top pin protruding out of the plastics material housing can be contaminated by depositing from the water in the water supply pipe, which could result in impairments with regard to the free mobility up and down of the top pin in the plastics material housing.

### BRIEF DESCRIPTION OF THE DRAWINGS

A preferred exemplary embodiment of the drinking valve as claimed in the invention is explained below by way of the drawing, in which, in detail:

FIG. 1 shows a schematic overview of a line watering trough with several drinking valves as claimed in the invention.

FIG. 2 shows a half section of the closed drinking valve which is screwed into a water supply pipe.

FIG. 3 shows the complete longitudinal section of the drinking valve of FIG. 2 in the open state not screwed into the water supply line.

### DETAILED DESCRIPTION OF PREFERRED EMBODIMENTS

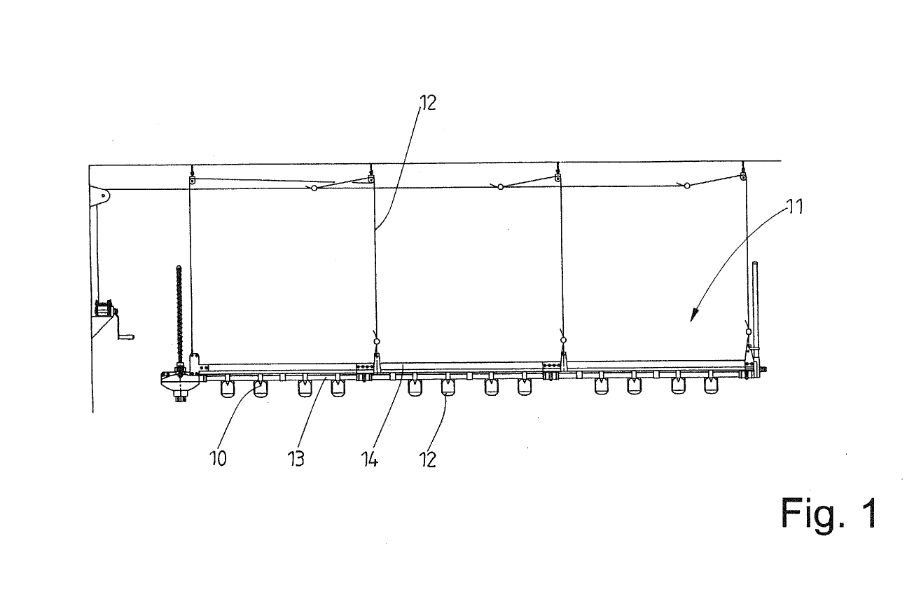

The drinking valve 10 according to the invention is explained in conjunction with a line watering trough shown in FIG. 1. FIG. 1 shows a watering line 11 of the line watering trough which is suspended by cables 12, preferably directed in a substantially horizontally manner, for example in a shed. The watering line 11 has a linear water supply pipe 13 which can be supplied with water for watering the animals, in particular poultry. An adjustable water pressure prevails in the interior of the water supply pipe 13. The water supply pipe 13 is fastened below a supporting profile 14 which is connected to the cables 12 for suspending the watering line 11.

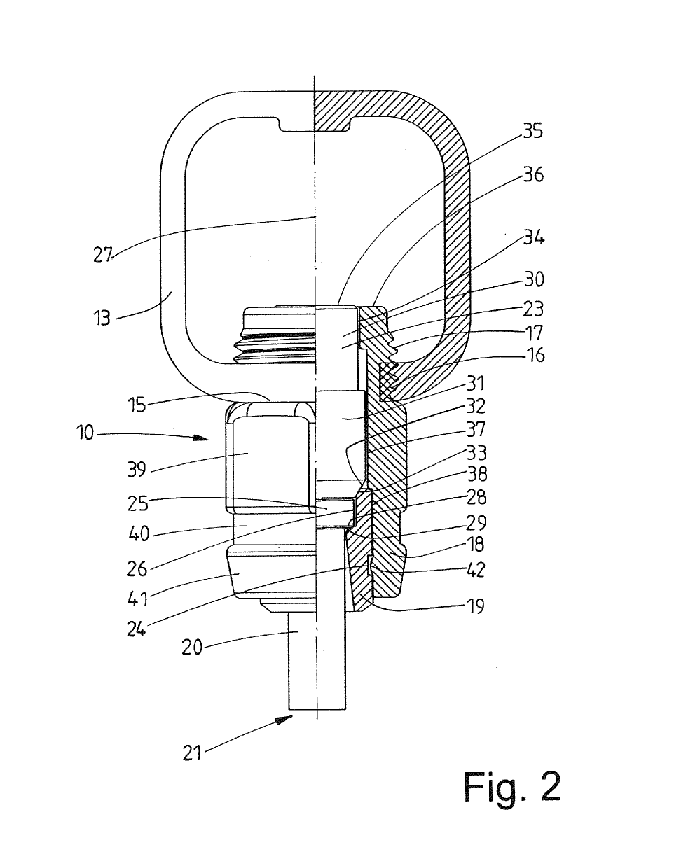

Several drinking valves 10 are screwed into the water supply pipe 13 at specific intervals, from below. In the case of the water supply pipe 13 with a rectangular cross section shown in FIG. 2, the drinking valves 10 are screwed into the water supply pipe 13 through a bottom, level horizontal wall 15. For this purpose, at the point where drinking valves 10 are to be arranged in the water supply pipe 13, the wall 15 has through bores with internal thread 16. A top part of the respective drinking valve 10 can be screwed in said internal thread 16 by way of a corresponding external thread 17. As a result, a liquid-tight connection between the respective drinking valve 10 and the water supply pipe 13 is produced.

In the embodiment shown, the drinking water output by the drinking valve 10 passes into a water collecting dish 22 which is fastened to the water supply pipe 13 in the region of each drinking valve 10. However, the drinking water can also be output directly from the opened drinking valve 10 to the respective animal, in particular a chicken, a chick or a turkey.

The drinking valve 10 according to the invention has a plastics material housing from a thermoplastic polymer, in a preferred manner from acrylonitrile-styrene-acrylester (ASA). Said plastics material stands out due to a good tolerance to chemicals. In particular, said plastics material is relatively resistant to aggressive chemical substances which are used, for example, for cleaning the drinking valve 10.

An insert sleeve 19, which extends approximately over one third of the length of the plastics material housing 18, is inserted from below into the plastics material housing 18. A valve pin 20 is displaceably mounted in the insert sleeve 19. The valve pin 20 protrudes in part, namely by way of a bottom end region, out of the insert sleeve 19 and the plastics material housing 18. Said region of the valve pin 20, which protrudes down out of the drinking valve 10, forms an actuating end 21 of the same, by way of which the animals can open the drinking valve 10 for the output of water by tilting and/or raising the valve pin 20.

A top pin 23 is additionally arranged in the plastics material housing 18 above the insert sleeve 19.

The valve pin 20, the insert sleeve 19 and the top pin 23 are formed from steel, preferably high-grade stainless steel. The steels of the insert sleeve 19, of the valve pin 20 and of the top pin 23 are different depending on the type of processing, namely machining or forming, but with regard to their resistance to aggressive media are of identical type or of identical value. This means that electrochemical corrosion between the valve pin 20, the insert sleeve 19 and the top pin 23 is prevented, in particular when they come into contact with aggressive chemical media.

The insert sleeve 19 is held with pre-stressing in a non-positive manner in the bottom end region of the plastics material housing 18. To reduce the stress created in this case in the plastics material housing 18, the insert sleeve 19 is provided on the outside the diameter with a circumferential, groove-like constriction 24. The constriction 24 preferably has a depth of just up to 6% of the outside diameter of the insert sleeve 19. The length of the constriction 24 amounts to between 10% and 20% of the length of the insert sleeve 19. The constriction 24 is situated at such a point, with reference to the length of the insert sleeve 19, at which is situated a region of the plastics material housing 18 at which the wall thickness of said plastics material housing is greater than in the remaining regions of the insert sleeve 19.

The plastics material housing 18, on the inner surfaces thereof, has a projection 42 which corresponds to the constriction 24 on the outer surface of the insert sleeve 19. The projection 42 is preferably realized as a circumferential, ring-like projection 42. The projection 42 is arranged at such a position of the inner surface of the plastics material housing 18 and is realized in such a manner that it engages in part in a positive manner in the constriction 24 in the insert sleeve 19. This means that the insert sleeve 19 is additionally secured in a positive manner against displacement in the plastics material housing 18. As a result of this, the pre-stressing between the plastics material housing 18 and the insert sleeve 19 is able to be reduced by the plastics material housing 18 not being expanded as much when the insert sleeve 19 is pressed into said plastics material housing. On account of the smaller amount of pre-stressing between the insert sleeve 19 and the plastics material housing 18, the mechanical load on the plastics material housing 18 is reduced, as a result of which it becomes more sturdy against chemical attacks of aggressive media, in particular cleaning agents.

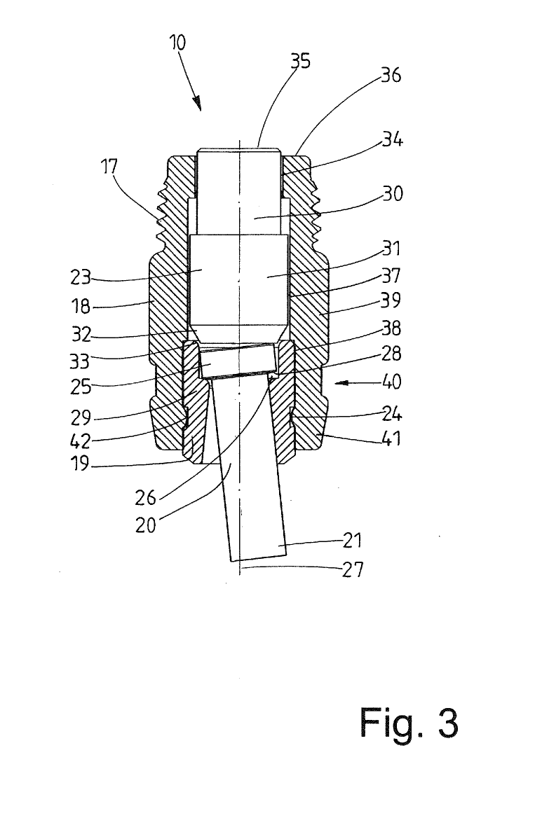

The valve pin 20 has a circumferential, narrow collar 25 at the top end thereof. The collar 25 has a cylindrical outside diameter which is greater than the diameter of the cylindrical part of the valve pin 20 located below with the actuating end 21 which protrudes down out of the insert sleeve 19. In the top end region of the insert sleeve 19 there is a cylindrical widening 26 for the collar 25 at the top end of the valve pin 20. The widening 26 is dimensioned such that the collar 25 is able to be received fully therein, even when the valve pin 20 is situated in the open position of the drinking valve 10 (FIG. 3). With the drinking valve 10 closed, when the longitudinal center axis of the valve pin 20 is situated on the longitudinal center axis 27 of the plastics material housing 18 and on the insert sleeve 19 arranged coaxially therein, a circumferential, ring-shaped sealing surface 28 on the under surface of the collar 25 of the valve pin 20 rests on a corresponding circumferential sealing seat 29 at the bottom end of the widening 26 of the insert sleeve 19. As a result, the valve pin 20 seals off on the insert sleeve 19 when the drinking valve 10 is situated in the closed position (FIG. 2).

The rotationally symmetrical, cylindrical top pin 23 is realized in a stepped manner. It has a top portion 30, the diameter of which is smaller than the bottom portion 31. The portions 30 and 31 are approximately of identical length, the top portion 30 preferably being slightly shorter. An end region of the bottom portion 31 is realized in the form of a truncated cone by means of a circumferential beveled edge which extends at an angle of approximately 30° to 40° with respect to the vertical longitudinal center axis 27. The inclinedly circumferential lateral surface of the truncated-cone-like beveled edge forms a circumferential sealing surface 32 at the bottom end of the top pin 23. A sealing seat 33, which is rounded off and corresponds to the sealing surface 32 below the top pin 23, is provided on the inner surface of the top end face of the insert sleeve 19. A preliminary sealing takes place between said sealing seat 33 at the top end of the insert sleeve 19 and the sealing surface 32 on the under surface of the top pin 23 when the drinking valve 10 is closed (FIG. 2).

At the top end, the plastics material housing 18 has a circumferential, cylindrical constriction 34 with a reduced diameter. Said diameter of the constriction 34 is somewhat greater than the diameter of the top portion 30 of the top pin 32. This means that a choke gap is created between the constriction 34 of the plastics material housing 18 and the top portion 30 of the top pin 23 with the smaller diameter, through which choke gap it is possible for water to flow from the water supply pipe 13 into the drinking valve 10, but which holds back solid particles. The length of the constriction 34 is approximately half as long as the length of the top portion 30 of the top pin 23 with the smaller diameter. This means that the top pin 23 can be moved up and down in the plastics material housing 18 in a sufficient manner in order to be able to raise the top pin 23 into the open position of the drinking valve 10 (FIG. 3) by tilting the valve pin 20.

The length of the top pin 23 is adapted to the length of the plastics material housing 18 in such a manner that, with the drinking valve 10 closed (FIG. 2), a top end face 35 of the top pin 23 projects or springs back up to 2 mm, in particular only up to 1 mm, from a top end face 36 of the plastics material housing 18. With the drinking valve 10 closed, the top end surface 35 preferably closes off in an approximately flush manner with the top end face. This means the top pin 23 does not project further into the water supply pipe 13 than a top end region of the plastics material housing 18.

The plastics material housing 18 is realized on the inside in a multiply stepped manner. Below the top constriction 34 there is a center region 37 in which the inside diameter of the plastics material housing 18 is somewhat greater than the inside diameter in the region of the constriction 34. The inside diameter in the center region 37 is preferably somewhat greater than the diameter of the bottom portion 31 of the top pin 23 such that between the top pin 23 and the plastics material housing 18 a narrow circumferential choke gap is created in the center region 37, through which choke gap water is able to flow from the water supply pipe 13 to the valve pin 20. A bottom end region 38 of the plastics material housing 18, in which the insert sleeve 19 is located, has an inside diameter which is even greater than the inside diameter in the center region 37. Said bottom end region 38 with the greater inside diameter serves to receive part, in particular a large part, of the insert sleeve 19.

The outer wall of the plastics material housing 18 is formed in a top region of the plastics material housing 18 by the external thread 17. The external thread 17 extends approximately over a third of the length of the plastics material housing 18. The plastics material housing 18 is provided with a hexagon 39 in a center region below the external thread 17. The hexagon 39 forms a driving flat for a tool for screw-connecting the drinking valve 10 into the internal thread 16 in the bottom wall of the water supply pipe 13 or for screwing the drinking valve 10 out of the water supply pipe 13. The width across flats of said hexagon 39 establishes the wall thickness of the plastics material housing 18 in the region of the hexagon 39. The plastics material housing 18 has a narrow, circumferential groove 40 below the hexagon. A bottom region 41 of the plastics material housing 18, which connects downward to the groove 40 and has a greater diameter than the groove 40, is realized in the manner of a truncated cone. The diameter of the bottom region 41 reduces toward the bottom end face of the plastics material housing 18. In the top region, the truncated-cone-like region 41 has a diameter which corresponds approximately to the width across corners of the hexagon 39.

The invention makes provision to realize the wall thickness of the plastics material housing 18 greater than is usual in the case of conventional drinking valves with a plastics material housing. With reference to the maximum inside diameter in the bottom end region 38 of the plastics material housing 18, the wall thickness of the same amounts to at least 17%, preferably at least 18%, of the inside diameter in the bottom end region 38. The maximum wall thickness of the plastics material housing 18 in the center region 37 and/or in the region of the constriction 34 amounts to up to 30% of the maximum inside diameter in the bottom end region 38, preferably 28.5%. In the case of the drinking valve 10 shown, wall thicknesses between 1.4 mm and 2.3 mm are produced in this manner. The average wall thickness of the plastics material housing 18 in the case of the drinking valve 10 shown lies within the range of between 1.8 mm and 2 mm, preferably 1.85 mm and 1.9 mm.

With reference to the maximum outside diameter of the plastics material housing 18 in the region of the hexagon 39, the wall thickness amounts to between a minimum of 10% and a maximum of 22%, in particular between 12% and 20%, preferably of the width across flats of the hexagon 39.

The wall thickness of the plastics material housing 18 with reference to the average inside diameter is between 20% and 32% of the average inside diameter. With reference to the average outside diameter, the wall thickness is between 12.5% and 20.5% of the average outside diameter.

The average wall thickness with reference to the average inside diameter amounts to between 24% and 28% of the average inside diameter, in particular between 26% and 27% of the average inside diameter. With reference to the average outside diameter, the average wall thickness amounts to between 16% and 18% of the average outside diameter, in particular approximately 17% of the average outside diameter. The average outside diameter in the case of plastics material housings 18 of the drinking valve 10 shown here is approximately between 11.0 mm and 11.3 mm. The average inside diameter is approximately between 7.0 mm and 7.3 mm.

The drinking valve 10 as claimed in the invention is suitable not only for line watering troughs shown in FIG. 1 but also for other animal watering troughs, with as well as without water collecting dishes 32.

### LIST OF REFERENCES

10 Drinking valve
11 Watering line
12 Cable
13 Water supply pipe
14 Supporting profile
15 Wall
16 Internal thread
17 External thread
18 Plastics material housing
19 Insert sleeve
20 Valve pin
21 Actuating end
22 Water collecting dish
23 Top pin
24 Constriction/indentation
25 Collar
26 Widening
27 Longitudinal center axis
28 Sealing surface
29 Sealing seat
30 Top portion
31 Bottom portion
32 Sealing surface
33 Sealing seat
34 Constriction
35 Top end surface
36 Top end face
37 Center region
38 Bottom end region
39 Hexagon
40 Groove
41 Bottom region
42 Projection

1. A drinking valve for animal watering troughs, such as poultry watering troughs, said drinking valve comprising:
a plastics material housing which can be connected to a water supply pipe;
a valve pin which protrudes in part down out of the plastics material housing; and
a top pin which is arranged above the valve pin,
wherein the plastics material housing has a wall thickness which amounts to at least 17% of the maximum inside diameter of the plastics material housing.

2. The drinking valve as claimed in claim 1, wherein the maximum wall thickness of the plastics material housing is 29% of the maximum inside diameter of the plastics material housing.

3. The drinking valve as claimed in claim 1, wherein:
the plastics material housing further comprises an outer surface and an inner surface, the outer surface and/or the inner surface of the plastics material housing having portions of different wall thicknesses,
with reference to the portion with a maximum inside diameter of the plastics material housing, the wall thickness of the plastics material housing is between 17% and 29% of the maximum inside diameter, and/or
with reference to the portion with a minimum inside diameter of the plastics material housing, the wall thickness of the plastics material housing is between 23% and 36% of the minimum inside diameter of the plastics material housing.

4. The drinking valve as claimed in claim 1, wherein:
the plastics material housing further comprises an outer surface and an inner surface,
the outer surface and/or the inner surface of the plastics material housing have portions of different wall thicknesses,
over at least half of an overall length of the plastics material housing, the wall thickness of the same plastics material housing is between 24% and 29% of an average inside diameter of the plastics material housing (18).

5. The drinking valve as claimed in claim 1, wherein the plastics material housing is formed from acrylonitrile-styrene-acrylester (ASA).

6. The drinking valve as claimed in claim 1, wherein the valve pin and the top pin are formed from the identical or at least the identical type of steel.

7. The drinking valve as claimed in claim 1, further comprising an insert sleeve of steel arranged in the plastics material housing, wherein the steel is identical to steel from which at least the valve pin or the top pin are produced or is at least of equal value.

8. The drinking valve as claimed in claim 6, the steel from which the valve pin and the top pin are formed is high-grade stainless steel.

9. The drinking valve as claimed in claim 7, wherein the insert sleeve extends only over a bottom, inner part region of the plastics material housing as far as up to the top pin.

10. The drinking valve as claimed in claim 7, wherein the insert sleeve has a circumferential sealing seat on a top end face thereof, said sealing seat corresponding with a circumferential sealing surface on a bottom end face of the top pin.

11. The drinking valve as claimed in claim 7, wherein an outer lateral surface of the insert sleeve has a circumferential constriction which extends over part of a length of the outer lateral surface of the insert sleeve.

12. The drinking valve as claimed in claim 11, wherein the constriction has a depth and the depth of the constriction amounts to up to 6% of an outside diameter of the insert sleeve outside the region of the constriction.

13. The drinking valve as claimed in claim 11, wherein the constriction has a length and the length of the constriction is between 10% and 20% of the length of the insert sleeve.

14. The drinking valve as claimed in claim 11, wherein in the region of the constriction of the insert sleeve, the plastics material housing has a projection which runs around the inside surface in a ring-like manner.

15. The drinking valve as claimed in claim 2, wherein:
the plastics material housing further comprises an outer surface and an inner surface, the outer surface and/or the inner surface of the plastics material housing having portions of different wall thicknesses,
with reference to the portion with a maximum inside diameter of the plastics material housing, the wall thickness of the plastics material housing is between 17% and 29% of the maximum inside diameter, and/or
with reference to the portion with a minimum inside diameter of the plastics material housing, the wall thickness of the plastics material housing is between 23% and 36% of the minimum inside diameter of the plastics material housing.

16. The drinking valve as claimed in claim 7, the steel from which the insert sleeve, the valve pin and the top pin are formed is high-grade stainless steel.
